(19) United States
(12) Patent Application Publication
(10) Pub. No.: US 2004/0078093 A1
(43) Pub. Date: Apr. 22, 2004

(54) Array-type processor

(75) Inventors: Taro Fujii, Kanagawa (JP); Koichiro Furuta, Kanagwa (JP); Masato Motomura, Kanagawa (JP); Kenichiro Anjo, Kanagawa (JP); Yoshikazu Yabe, Kanagawa (JP); Toru Awashima, Kanagawa (JP); Takao Toi, Kanagawa (JP); Noritsugu Nakamura, Kanagawa (JP)

Correspondence Address: FOLEY AND LARDNER, SUITE 500, 3000 K STREET NW, WASHINGTON, DC, 20007, US

(73) Assignee: NEC ELECTRONICS CORPORATION

(21) Appl. No.: 10/682,736

(22) Filed: Oct. 10, 2003

(30) Foreign Application Priority Data
Oct. 11, 2002 (JP) 2002-299028

(51) Int. Cl. G05B 19/18

(52) U.S. Cl. 700/2; 700/5

(57) ABSTRACT

A multiplicity of processor elements, which individually execute data processing in accordance with instruction codes that are individually set and for which the connection relation between processor elements is switch-controlled, are arranged in a matrix; and the instruction codes of the multiplicity of processor elements are successively switched by a state control unit. The state control unit is composed of a plurality of units that intercommunicate to realize linked operation, the multiplicity of processor elements is divided into a plurality of element groups, and the plurality of state control units and the plurality of element groups are individually connected, whereby a plurality of small-scale state transitions can be individually controlled by the state control units, or a single large-scale state transition can be controlled through the cooperation of the plurality of state control units.

### BACKGROUND OF THE INVENTION

1. Field of the Invention

The present invention relates to an array-type processor in which a multiplicity of processor elements that each individually executes data processing and for which the connection relations between the processor elements is switch-controlled are arranged in rows and columns and in which the operations of this multiplicity of processor elements are controlled by a state control unit.

2. Description of the Related Art

Products referred to as CPUs (Central Processing Units) and MPUs (Micro Processor Units) are currently in practical use as processor units that can freely execute various types of data processing.

In data processing systems that employ these processor units, various application programs that are described by a plurality of instruction codes and various types of processing-data are stored in memory devices, the processor units read these instruction codes and processing data in order from the memory devices and successively execute a plurality of operations.

A single processor unit can therefore execute various types of data processing, but in this data processing, the plurality of operations must be successively executed in order and the processor unit must read the instruction codes from the memory device for each successive process, and it is therefore difficult to execute complex data processing at high speed.

On the other hand, when the data processing that is to be executed is limited to a single type, constructing logic circuits to execute this data processing by hardware eliminates the need for a processor unit to read a plurality of instruction codes from memory devices in order and then successively execute the plurality of operations in order. Thus, although complex data processing can be executed at high speed, obviously, only a single type of data processing can be executed.

In other words, a data processing system that allows free switching of application programs enables the execution of various type of data processing, but the execution of high-speed data processing is problematic because the configuration of the hardware is fixed. On the other hand, logic circuits that are constituted by hardware enable high-speed execution of data processing but can execute only one type of data processing because they do not permit modification of the application program.

With the aim of solving this problem, the present applicant has invented and submitted an application for an array-type processor as a data processing device in which the hardware configuration changes in accordance with software (please refer to Japanese Patent Laid-Open Publication No. 2001-312481).

In this array-type processor, a multiplicity of small-scale processor elements are arranged in rows and columns together with a multiplicity of switch elements in a datapath unit, one state control unit being provided together with one of these data path units. The multiplicity of processor elements each individually execute data processing in accordance with instruction codes in which data are individually set, and switching of connection relations is controlled by a multiplicity of switch elements that are individually provided together with the processor elements.

The array-type processor can therefore execute various types of data processing in accordance with software because the configuration of the data paths is changed by switching the instruction codes of the multiplicity of processor elements and the multiplicity of switch elements, and can execute data processing at high speed because, as hardware, a multiplicity of small-scale processor elements simultaneously execute simple data processing.

The array-type processor can continuously execute simultaneous processing in accordance with a computer program because the context of the datapath unit, which is made up of the instruction codes of the above-described multiplicity of processor elements and multiplicity of switch elements, is successively switched by a state control unit for each operation cycle in accordance with the computer program.

Although the above-described array-type processor can execute high-speed data processing by means of a multiplicity of processor elements, the state transitions of this multiplicity of processor elements is managed by a single state control unit. As a consequence, executing, for example, two loop transitions, one of four states and the other of six states, together as shown in FIG. 1 calls for a minimum of 12 states, 12 being the smallest common multiple of 4 and 6. When the number of combined state transitions or the number of states of each transition increases in this way, the number of states expands greatly and interferes with the operating efficiency of the array-type processor. In particular, when condition branches exist in the state transitions, the number of states that are to be managed expands greatly and control in the state control unit becomes problematic.

### SUMMARY OF THE INVENTION

The present invention was realized in view of the above-described problems and has as an object the provision of an array-type processor that can operate effectively even when simultaneously executing a plurality of state transitions.

In the array-type processor of the present invention, a multiplicity of processor elements, which individually execute data processing in accordance with instruction codes in which data are individually set and for which the connection relations between the processor elements are switch-controlled, are arranged in rows and columns, and the instruction codes of this multiplicity of processor elements are successively switched by a state control unit.

In the first invention of the above-described array-type processor, the state control unit is composed of a plurality of units, the multiplicity of processor elements is divided into a number of element groups that corresponds to the number of state control units, and the plurality of state control units and the plurality of element groups are individually connected.

As a result, a plurality of small-scale state transitions is separately controlled by the plurality of state control units, or a single large-scale state transition is controlled by a plurality of cooperating state control units. Further, the plurality of state control units and the plurality of element groups are individually connected, and the plurality of state control units is therefore connected to the multiplicity of processor elements by a minimal and simple connection configuration.

In the second invention of the previously described array-type processor, the state control unit is composed of a plurality of units and a variable connection means is included for enabling free variation of the connection relations between at least a portion of the plurality of state control units and at least a portion of the multiplicity of processor elements.

As a result, a plurality of small-scale state transitions is individually controlled by the plurality of state control units, or a single large-scale state transition is controlled by the plurality of cooperating state control units. Further, the ability to freely vary the connection relation between the plurality of state control units and the multiplicity of processor elements allows various types of control of the states of the multiplicity of processor elements by the plurality of state control units.

In the present invention, “plurality” means any integer equal to or greater than 2, and “multiplicity” means any integer that is greater than the above-described “plurality.”

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a schematic view showing a state in which two state transitions are integrated as one;

FIG. 2 is a schematic block diagram showing an array-type processor according to the first embodiment of the present invention;

FIG. 3 is a block diagram showing the physical construction of, for example, m/nb-buses of an array-type processor;

FIG. 4 is a block diagram showing the physical configuration of an instruction buses;

FIG. 5 is a schematic view showing the array-type processor of the first embodiment;

FIG. 6 is a schematic block diagram showing the array-type processor of the second embodiment;

FIG. 7 is a schematic block diagram showing the array-type processor of the third embodiment;

FIG. 8 is a schematic block diagram showing the array-type processor of the fourth embodiment;

FIG. 9 is a schematic block diagram showing the array-type processor of the fifth embodiment;

FIG. 10 is a schematic block diagram showing the array-type processor of the sixth embodiment;

FIG. 11 is a schematic block diagram showing the array-type processor of the seventh embodiment;

FIG. 12 is a schematic block diagram showing the array-type processor of the eighth embodiment;

FIG. 13 is a schematic block diagram showing the array-type processor of the ninth embodiment; and

FIG. 14 is a schematic block diagram showing the array-type processor of the tenth embodiment.

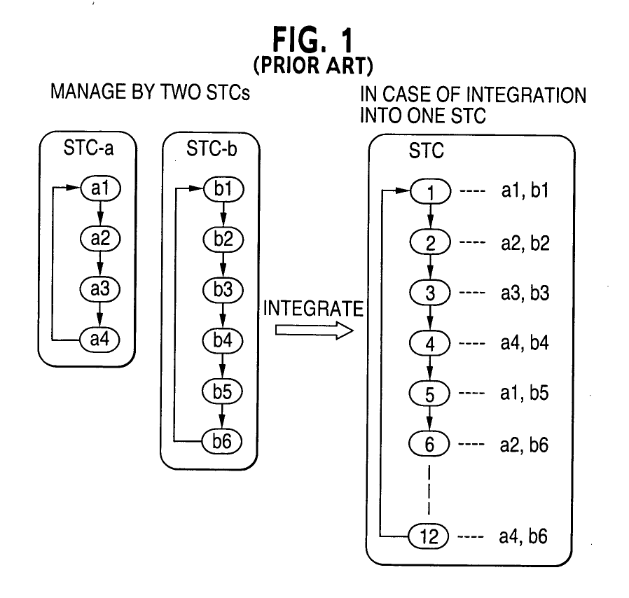

### DETAILED DESCRIPTION OF THE PREFERRED EMBODIMENTS

Construction of the First Embodiment

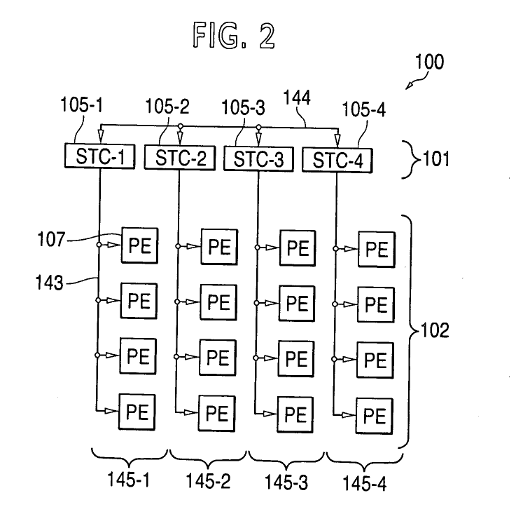

The first embodiment of the present invention is next described with reference to FIGS. 2 to 4. As shown in FIG. 4, array-type processor 100 of the present embodiment includes as its principal construction control unit array 101, datapath unit 102, memory controller 103, and read multiplexer 104.

Control unit array 101 includes a plurality of state control units 105, and datapath unit 102 includes a multiplicity of processor elements 107. In the interest of simplifying the following explanation, four state control units 105 are arranged in control unit array 101, and 16 processor elements 107 are arranged in four rows and four columns in datapath unit 102, as shown in the figures.

Memory controller 103 transfers various data that are received as input from the outside to state control units 105 and datapath unit 102; and read multiplexer 104 supplies as output to the outside the various types of data that have been read from datapath unit 102. Datapath unit 102 executes data processing with the various types of data that have been received as input from memory controller 103, and supplies the various types of data that have been processed as output to read multiplexer 104. Control unit array 101, by managing the state transitions of datapath unit 102, causes datapath unit 102 to execute various types of data processing.

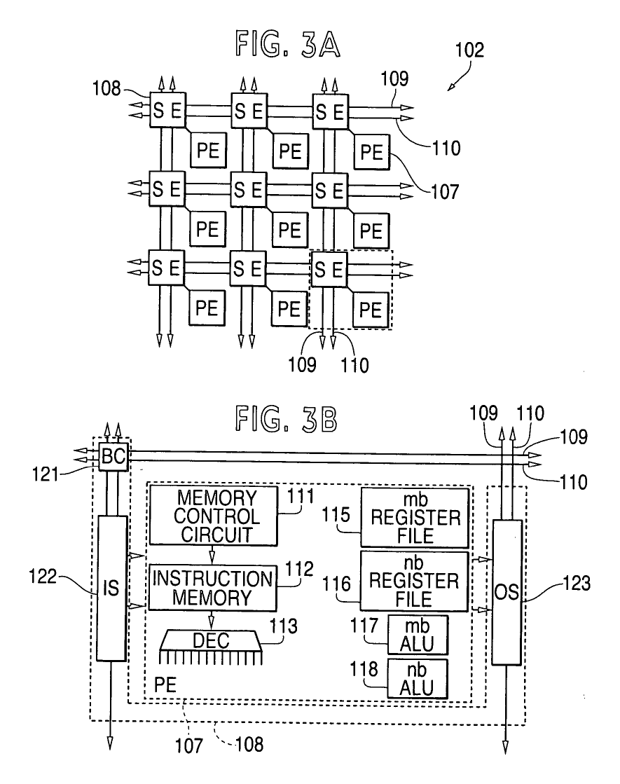

To explain in greater detail, datapath unit 102 includes a multiplicity of processor elements 107, a multiplicity of switch elements 108, a multiplicity of mb (m-bit) buses 109, and a multiplicity of nb (n-bit) buses 110, as shown in FIGS. 3 and 4, the multiplicity of processor elements 107 together with the multiplicity of switch elements 108 being arranged in rows and columns and connected as a matrix by the multiplicity of m/nb-buses 109 and 110.

In addition, as shown in FIG. 3B, each processor element 107 includes each of memory control circuit 111, instruction memory 112, instruction decoder 113, mb register file 115, nb register file 116, mb-ALU (Arithmetic and Logical Unit) 117, nb-ALU 118, and internal variable wiring (not shown in the figures); and each switch element 108 includes each of bus connector 121, input control circuit 122, and output control circuit 123.

Further, as shown in FIG. 4, each of the plurality of state control units 105 includes instruction decoder 138, transition table memory 139, and instruction memory 140; instruction decoder 138 and memory controller 103 being connected by instruction bus 141.

The four rows of instruction buses 142 from memory controller 103 to read multiplexer 104 are connected in parallel, and each row of these four rows of instruction buses 142 is connected to memory control circuits 111 of the four columns of processor elements 107.

In addition, four columns of address buses 143 are each connected to instruction decoder 138 of one state control unit 105, and these address buses 143 are each connected to memory control circuits 111 in the four rows of processor elements 107. Instruction bus 141 is formed with a bus width of, for example, “20 (bits)”, and instruction buses 142 and address buses 143 are formed with a bus width of, for example, “8 (bits)”.

In array-type processor 100 of the present embodiment, however, the four rows and four columns of processor elements 107 of datapath unit 102 are divided between four columns of element groups 145-1--145-4, and the four state control units 105-1--105-4 are therefore each connected by four columns of address buses 143 to a respective group of four element groups 145-1--145-4.

Memory controller 103 is connected in parallel to the four state control units 105-1--105-4 by instruction bus 141, and as shown in FIG. 2, the four state control units 105-1--105-4 are also connected by dedicated communication line 144 for realizing mutual communication.

In array-type processor 100 of the present embodiment, however, four rows and four columns of processor elements 107 are divided into the four columns of element groups 145-1--145-4 that correspond to the four state control units 105, and the four state control units 105 and four columns of element groups 145-1--145-4 are each connected as shown in FIGS. 2 and 4.

As a result, in array-type processor 100 of the present embodiment, each of the four state control units 105 controls the states of only the four rows of processor elements 107 of the element group column of element groups 145-1--145-4 to which that state control unit 105 is connected, and the four state control units 105-1--105-4 operate in concert with each other through intercommunication by way of communication line 144.

In array-type processor 100 of the present embodiment, moreover, the instruction codes of the multiplicity of processor elements 107 and the multiplicity of switch elements 108 that are arranged in rows and columns in datapath unit 102 are data-set in a computer program that is supplied from the outside as contexts that successively switch, and the instruction codes of state control units 105 that switch these contexts for each operation cycle are data-set as operation states that make successive transitions.

Thus, as shown in FIG. 4, the above-described instruction codes of state control units 105 are stored in instruction memory 140, and transition rules for causing successive transitions of a plurality of operating states are stored in transition table memory 139.

State control units 105 cause the operation states to undergo successive transitions in accordance with the transition rules of transition table memory 139, and by means of the instruction codes of instruction memory 140, generate the instruction pointers of processor elements 107 and switch elements 108.

As shown in FIG. 3B, switch elements 108 share the instruction memories 112 of adjacent processor elements 107, and state control units 105 supply the generated instruction pointers of processor elements 107 and switch elements 108 to instruction memory 112 of corresponding processor elements 107.

The plurality of instruction codes of processor element 107 and switch element 108 are stored in this instruction memory 112, and the instruction codes of processor element 107 and switch element 108 are designated by a single instruction pointer that is supplied from state control units 105. Instruction decoder 113 decodes the instruction codes that have been designated by the instruction pointer and controls the operations of switch element 108, internal variable lines, and m/nb-ALU 117 and 118.

Since mb-buses 109 transfer processing data of mb, which is “8 (bits)”, and nb-buses 110 transfer processing data of nb, which is “1 (bit)”, switch elements 108 control the connection relation of the multiplicity of processor elements 107 by means of m/nb-buses 109 and 110 in accordance with the operation control of instruction decoder 113.

To state in greater detail, bus connectors 121 of switch elements 108 link in four directions with mb-buses 109 and nb-buses 110 and control the connection relation of the plurality of mb-buses 109 and the connection relation of the plurality of nb-buses 110.

Thus, in array-type processor 100, state control units 105 successively switch the contexts of datapath unit 102 for each operation cycle in accordance with a computer program that is supplied from the outside, and the multiplicity of processor elements 107 each operate simultaneously on data processing that can be individually and freely set.

Input control circuit 122 controls the connection relation of data input from mb-buses 109 to mb register file 115 and mb-ALU 117 and the connection relations of data input from nb-buses 110 to nb-register file 116 and nb-ALU 118, as shown in FIG. 3B.

Output control circuit 123 controls the connection relations of data output from mb-register file 115 and mb-ALU 117 to mb-buses 109 and the connection relations of data output from nb-register file 116 and nb-ALU 118 to nb-buses 110.

The internal variable lines of processor elements 107, in accordance with the operation control of instruction decoder 113, control the connection relations of mb-register files 115 and mb-ALU 117 inside processor elements 107 and the connection relations of nb-register files 116 and nb-ALU 118.

In accordance with the connection relations that are controlled by internal variable lines, mb-register file 115 temporarily holds the m bits of processing data that are received as input from, for example, mb-buses 109 and supplies the processing data as output to, for example, mb-ALU 117. In accordance with the connection relations that are controlled by internal variable lines, nb-register file 116 temporarily holds the n-bits of processing data that are received as input from, for example, nb-buses 110, and supplies the processing data as output to, for example, nb-ALU 118.

Using the m-bits of processing data, mb-ALU 117 executes data processing in accordance with the operation control of instruction decoder 113, and nb-ALU 118, using the n-bits of processing data, executes data processing in accordance with the operation control of instruction decoder 113, whereby data processing of m/nb that corresponds to the number of bits of processing data is appropriately executed.

The processing results of this datapath unit 102 are fed back as event data to state control units 105 according to necessity, and these state control units 105 use the event data input to cause operating states to both make the transition to the next operating state and switch the context of the datapath unit 102 to the next context.

Operation of the First Embodiment

In a construction such as the one described in the foregoing explanation, when executing data processing using processing data that have been received as input from the outside in accordance with a computer program that is supplied from the outside in array-type processor 100 of the present embodiment, state control units 105 both cause successive transitions of the operating states and successively switch the contexts of datapath unit 102 with each operation cycle.

Thus, for each of these operation cycles, the multiplicity of processor elements 107 operate simultaneously on data processing that is freely set individually, and the connection relations of this multiplicity of processor elements 107 are switch-controlled by a multiplicity of switch elements 108. At this time, the processing results in datapath unit 102 are fed back as event data to state control units 105 according to necessity, and these state control units 105 use the received event data both to cause the transitions of operating states to the next operating states and to switch the context of datapath unit 102 to the context of the next stage.

In array-type processor 100 of the present embodiment, data processing is executed by the state transitions of the contexts of datapath unit 102 that are brought about by state control units 105 as previously described, but the four state control units 105 separately control the states of each of processor elements 107 in the four rows of the four columns of element groups 145-1--145-4 that are connected to the four state control units 105, and the four state control units 105-1--105-4 communicate with each other and operate in concert.

As a result, not only is it possible to execute a single state transition of data processing in all of processor elements 107 of the four rows and four columns of datapath unit 102, but it is also possible to, for example, separately execute four state transitions in each of the four columns of element groups 145-1--145-4.

Similarly, two state transitions can be separately executed in pairs of adjacent columns of the four columns of element groups 145-1--145-4, or three state transitions can be separately executed in one column and three adjacent columns of the four columns of element groups 145-1--145-4.

Effect of the First Embodiment

As described above, in array-type processor 100 of the present embodiment, four rows and four columns of processor elements 107 are divided into four columns of element groups 145-1--145-4, four state control units 105-1--105-4 separately control the states of these element groups 145-1--145-4, and these four state control units 105-1--105-4 intercommunicate to operate in concert.

As a result, a plurality of small-scale state transitions can be separately controlled by four state control units 105-1--105-4, or, by having the four state control units 105-1--105-4 operate in concert to operate similar to a single state control unit, the four state control units 105-1--105-4 can work together to control one large-scale state transition.

In particular, the four state control units 105-1--105-4 and the four columns of element groups 145-1--145-4 are able to operate in complete independence, and it is therefore possible to, for example, cause the operation clocks of the four state control units 105-1--105-4 and four columns of element groups 145-1--145-4 to operate at different phases.

Array-type processor 100 of the present embodiment, moreover, is also readily amenable to miniaturization and is well suited for high productivity because the four state control units 105-1--105-4 are separately connected to the four columns of element groups 145-1--145-4, whereby the four state control units 105-1--105-4 connect to the four rows and four columns of processor elements 107 by the minimum, simple connection configuration.

Further, in array-type processor 100 of the present embodiment, processor elements 107 that are arranged in rows and columns are divided into element groups 145 according to the matrix form, thereby simplifying the structure and facilitating state control by the plurality of state control units 105.

Example of a Modification of the First Embodiment

The present invention is not limited to the above-described embodiment and is open to a variety of modifications within the scope of the invention. For example, although an example was described in the above-described embodiment in which four state control units 105-1--105-4 are connected to the four columns of element groups 145-1--145-4 of the four rows and four columns of processor elements 107, the numbers and arrangement can of course be freely modified.

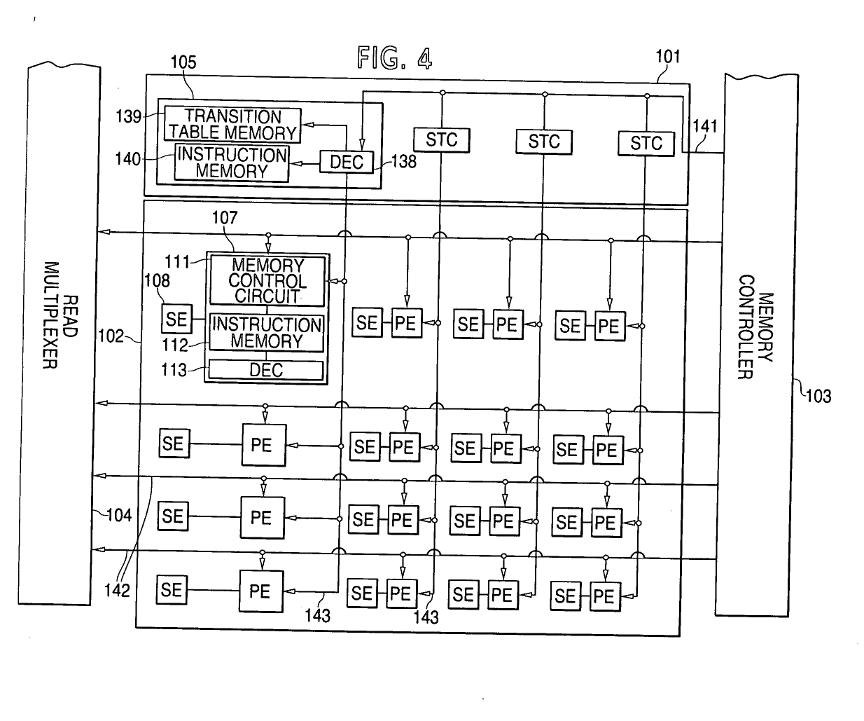

For example, although the four rows and four columns of processor elements 107 are divided into four columns of element groups 145-1--145-4 in array-type processor 100 of the above-described embodiment, each of four element groups 145 can be constituted by four rows and four columns of processor elements 107 as shown in the example of array-type processor 150 in FIG. 5.

Further, although a case was described in which element groups 145 are each constituted by one column of processor elements 107 that are arranged in matrix form in array-type processor 100 of the above-described embodiment, the element groups may be constituted by a plurality of columns, a row, or a plurality of rows of processor elements 107, or the element groups may be constituted by other more irregular forms.

In addition, although a case was described in array-type processor 100 of the above-described embodiment in which state control units 105 are positioned at one end of element groups 145, state control units 105 may also be arranged in the center of element groups 145 as in the above-described array-type processor 150. In this case, the average distance between state control units 105 and processor elements 107 can be shortened, and the operating speed can be correspondingly increased.

Still further, although an example was presented in array-type processor 100 of the above-described embodiment in which the plurality of state control unit 105 communicate with each other simply on the same level to realize linked operation, it is also possible to, for example, establish one of the plurality of state control units 105 as a higher-order master and set the others as lower-order slaves, or to provide a dedicated master circuit (not shown in the figures) that has a higher rank than the plurality of state control units 105.

Further, in array-type processor 100 of the above-described embodiment, an example was described in which processor elements 107 that each include m/nb-register files 115 and 116 and m/nb-ALU 117 and 118 are connected by m/nb-buses 109 and 110 and in which data processing and data communication was executed by m bits and n bits.

However, it is also possible to execute data processing and data communication using three or more numbers of bits on hardware of three or more numbers of bits as well as to execute data processing and data communication using a single type of bit number on hardware of a single bit number.

Although a case was described in array-type processor 100 of the above-described embodiment in which the plurality of state control units 105 communicate with each other by dedicated communication line 144 to realize linked operation, it is also possible for this mutual communication to be realized by, for example, m/nb-buses 109 and 110 of datapath unit 102 and for communication line 144 to be omitted.

In array-type processor 100 of the above-described embodiment, a case was described in which adjacent processor elements 107 and switch elements 108 share instruction memory 112 and in which the instruction codes of processor elements 107 and switch elements 108 are generated by a single instruction pointer.

However, dedicated instruction memories may also be separately prepared for processor elements 107 and switch elements 108, and the instruction codes for processor elements 107 and switch elements 108 can each be separately generated by dedicated instruction pointers.

In the interest of simplifying both the figure and explanation in the above-described embodiment, one mb-bus 109 and one nb-bus 110 are connected in the horizontal and vertical directions for each processor element 107, but in actuality, a plurality of mb-buses 109 and nb-buses 110 are ideally connected to each processor element 107.

Finally, in the above-described embodiment, a case was described in which a plurality of state control units 105 communicate with each other to realize linked operation, but it is also possible, for example, for a plurality of data processing to be separately executed by a plurality of element groups 145 without the linked operation of a plurality of state control units 105. In this case, it is possible for a plurality of data processing to be executed independently and simultaneously. For example, a series of data processing can be divided into a plurality of steps and then executed in stages by a plurality of element groups 145.

Construction of the Second Embodiment

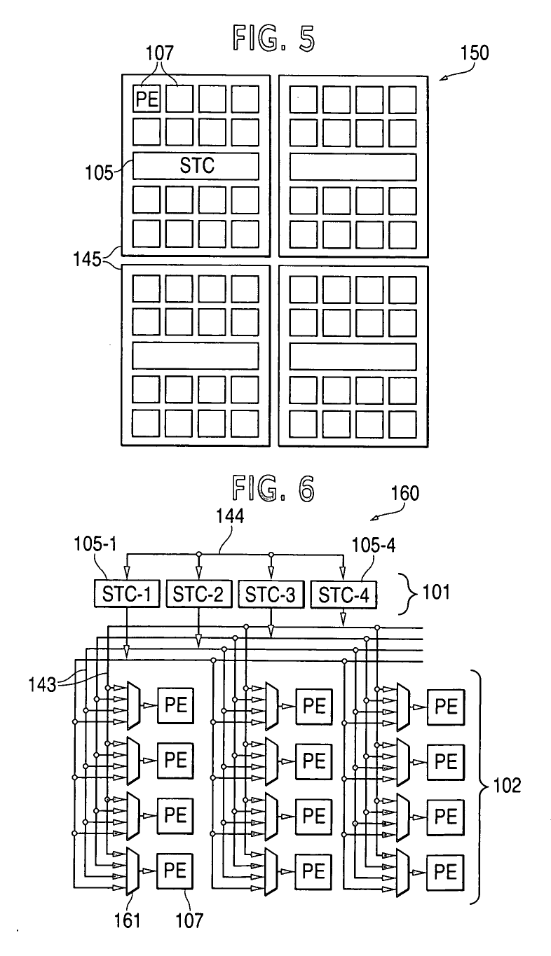

The second embodiment of the present invention is next described with reference to FIG. 6. In the descriptions of this and following embodiments, parts that are identical to those of preceding embodiments are identified using the same names and reference numerals, and redundant explanation of such parts is omitted.

In array-type processor 160 of the present embodiment, all of a plurality of state control units 105 and all of a multiplicity of processor elements 107 are freely and selectively connected or cut off by switches 161, which is a variable connection means. In addition, the control terminals of switches 161 are connected to, for example, adjacent processor elements 107, and these processor elements 107 control the operation of adjacent switches 161.

Operation of the Second Embodiment

In array-type processor 160 of the present embodiment of the above-described construction, a plurality of state control units 105 and a multiplicity of processor elements 107 are freely connected or cut off by way of switches 161, whereby the numbers and positions of processor elements 107 that are state-controlled by each of the plurality of state control units 105 can be varied freely.

Effects of the Second Embodiment

In array-type processor 160 of the present embodiment as described hereinabove, the connection relation between a plurality of state control units 105 and a multiplicity of processor elements 107 can be freely varied, whereby the degree of freedom of the state control of processor elements 107 that is exercised by the plurality of state control units 105 can be maximized. Further, in array-type processor 160 of the present embodiment, for example, all processor elements 107 can be connected to a single state control unit 105 and the states thus controlled, whereby only one state control unit 105 need operate and the need for the linked operation of a plurality of state control units is eliminated.

A comparison of array-type processor 100 of the first embodiment and array-type processor 160 of the second embodiment shows that, although the degree of freedom of state control is at a minimum in first array-type processor 100, the redundancy of address buses 143 is also a minimum; and although the degree of freedom of state control is at a maximum in second array-type processor 160, the redundancy of address buses 143 is also at a maximum.

In other words, these array-type processors 100 and 160 each have advantages and disadvantages, and when implementing a product, the various conditions should be taken into consideration to select the most suitable form, or a construction should be realized having a lower degree of redundancy than second array-type processor 160 and a greater degree of freedom than first array-type processor 100. Embodiments having these types of constructions are explained hereinbelow.

Construction of the Third Embodiment

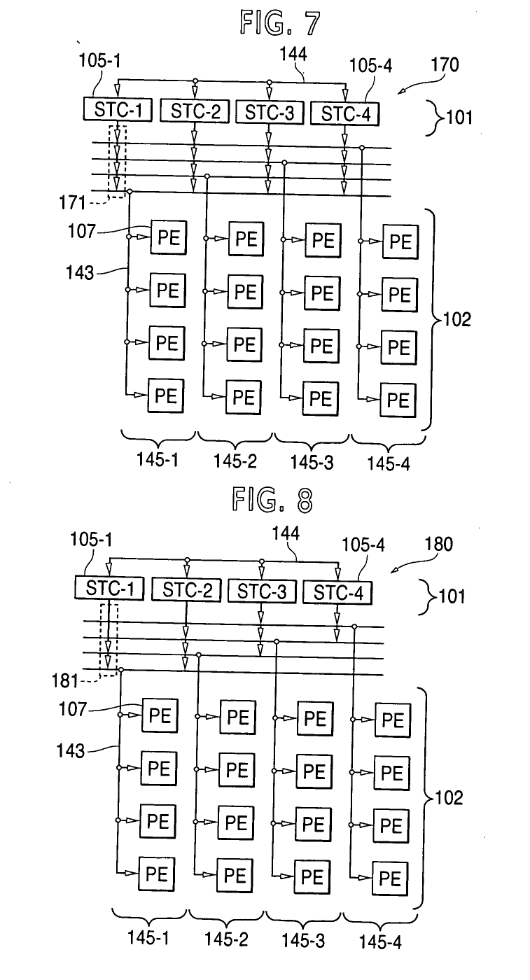

The third embodiment of the present invention is next explained with reference to FIG. 7. In array-type processor 170 of this embodiment, four rows and four columns of processor elements 107 are divided into four columns of element groups 145, and these four columns of element groups 145 and four state control units 105 are freely and selectively connected or disconnected by switches 171, which are the variable connection means.

Operation of the Third Embodiment

In array-type processor 170 of the present embodiment of the above-described construction, four state control units 105 and four columns of element groups 145 are freely connected and disconnected by means of switches 171, whereby the numbers and positions of element groups 145 that the four state control units 105 individually state-control can be freely varied.

Effect of the Third Embodiment

In array-type processor 170 of the present embodiment as described hereinabove, the connection relation between a plurality of state control units 105 and a multiplicity of processor elements 107 can be varied with element groups 145 as a unit, and the redundancy of address buses 143 is therefore lower than in second array-type processor 160 while the degree of freedom of state control is greater than in first array-type processor 100. Array-type processor 170 of the present embodiment is particularly suitable when data processing by means of processor elements 107 can be realized in units of element groups 145.

However, although the connection relation between all four state control units 105-1--105-4 and all four columns of element groups 145-1--145-4 can be freely switched in array-type processor 170 of the present embodiment, the connection of, for example, first state control unit 105-1 to fourth element group 145-4 and fourth state control unit 105-4 to first element group 145-1 only reduces the data transfer rate between state control units 105 and element groups 145, and offers few advantages.

In other words, in a construction that enables freedom in the switching of connection relations between a plurality of state control units 105 and a plurality of element groups 145, the limitation on the connection relations may slightly reduce the degree of freedom but can greatly reduce the degree of redundancy.

Fourth Embodiment

In array-type processor 180 that is shown in FIG. 8, for example, nth state control unit 105-n and (n±1)th element group 145-(n±1) are freely connected and disconnected by regulating the switching relation by means of switches 181, which are the variable connection means.

More specifically, first state control unit 105-1 is freely connected to and disconnected from first and second element groups 145-1 and 145-2; and second state control unit 105-2 is freely connected to or disconnected from first to third element groups 145-1--145-3.

Third state control unit 105-3 is freely connected to or disconnected from second to fourth element groups 145-2--145-4; and fourth state control unit 105-4 is freely connected to or disconnected from third and fourth element groups 145-3 and 145-4. As a result, first element group 145-1 and fourth element group 145-4 are never connected to the same state control unit 105.

Because the plurality of state control units 105 are freely connected to or disconnected from only neighboring element groups 145 in this array-type processor 180, the degree of freedom of state control is slightly reduced compared to the previously described array-type processor 170, but the redundancy of the wiring structure can be greatly reduced.

Fifth Embodiment

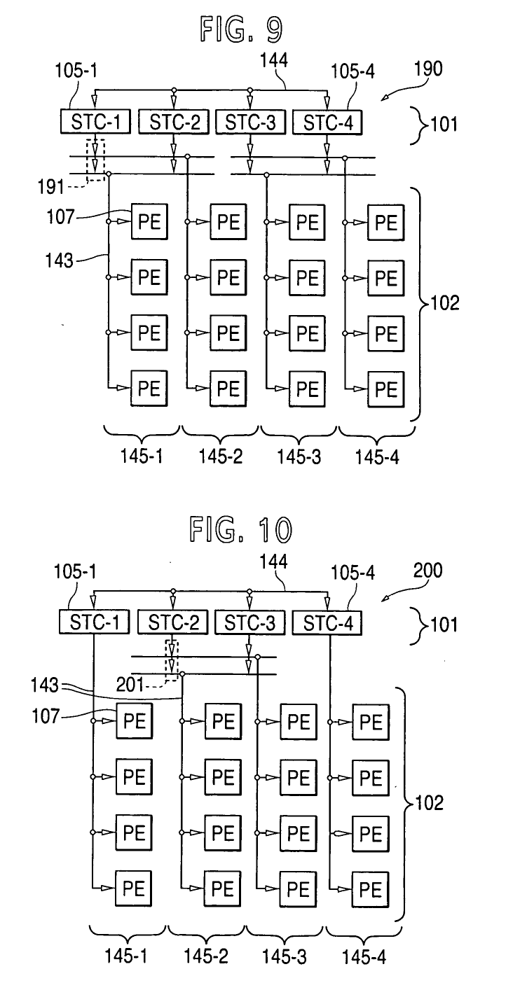

In array-type processor 190 that is shown in FIG. 9, regulating the connection relations that are switched by switches 191, i.e., the variable connection means, allows a portion of the plurality of state control units 105 to be freely connected to or disconnected from one portion of the plurality of element groups 145, and the other portion of the plurality of state control units 105 to be freely connected to or disconnected from the other portion of the plurality of element groups 145.

More specifically, first and second state control units 105-1 and 105-2 are freely connected to or disconnected from first and second element groups 145-1 and 145-2; and third and fourth state control units 105-3 and 105-4 are freely connected to or disconnected from third and fourth element groups 145-3 and 145-4.

Sixth Embodiment

In array-type processor 200 that is shown in FIG. 10, a portion of the plurality of state control units 105 is fixedly connected to a portion of the plurality of element groups 145, and the other portion of the plurality of state control units 105 is freely connected to or disconnected from the other portion of the plurality of element groups 145.

More specifically, first state control unit 105-1 is fixedly connected to first element group 145-1 and fourth state control unit 105-4 is fixedly connected to fourth element group 145-4, but second and third state control units 105-2 and 105-3 are freely connected to or disconnected from second and third element groups 145-2 and 145-3 by means of switches 201, which are the variable connection means.

Seventh Embodiment

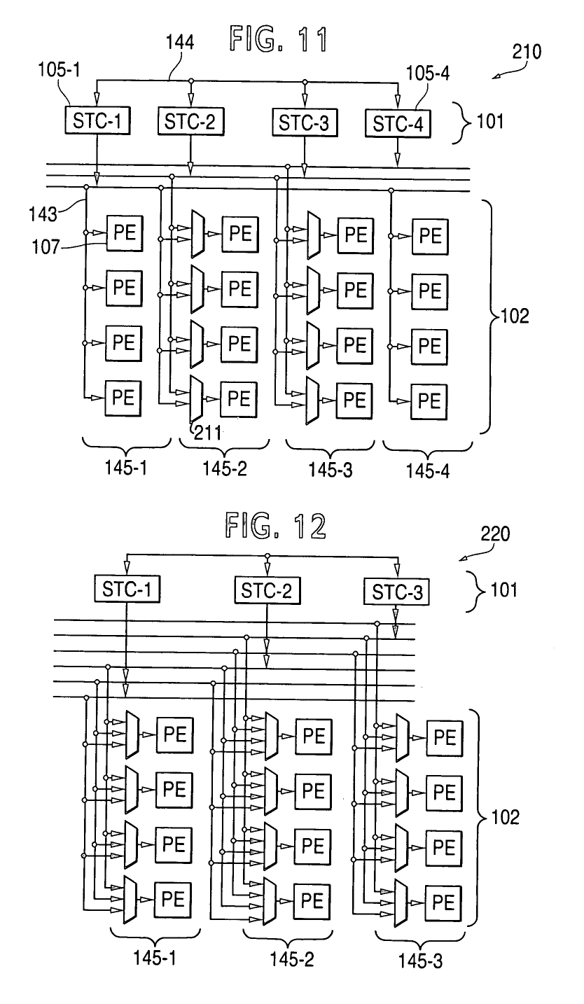

In array-type processor 210 that is shown in FIG. 11, a portion of the plurality of state control units 105 is both fixedly connected to prescribed element groups 145 and freely connected to or disconnected from processor elements 107 of prescribed element groups 145, and the remaining portion of the plurality of state control units 105 is freely connected to or disconnected from processor elements 107 of prescribed element groups 145.

More specifically, first state control unit 105-1 is both fixedly connected to first element group 145-1 and freely connected to or disconnected from processor elements 107 of second element group 145-2 by means of switches 211, which are the variable connection means.

Second and third state control units 105-2 and 105-3 are freely connected to or disconnected from processor elements 107 of second and third element groups 145-2 and 145-3 by means of switches 211; and fourth state control unit 105-4 is both freely connected to or disconnected from processor elements 107 of third element group 145-3 by means of switches 211 and fixedly connected to fourth element group 145-4.

Eighth Embodiment

In array-type processor 220 that is shown in FIG. 12, each of the plurality of state control units 105 is freely connected to or disconnected from processor elements 107 of prescribed element groups 145.

More specifically, first state control unit 105-1 is freely connected to or disconnected from processor elements 107 of first and second element group 145-1 and 145-2, second state control unit 105-2 is freely connected to or disconnected from processor elements 107 of first to third element groups 145-1--145-3, and third state control unit 105-3 is freely connected to or disconnected from processor elements 107 of second and third element groups 145-2 and 145-3.

Ninth Embodiment

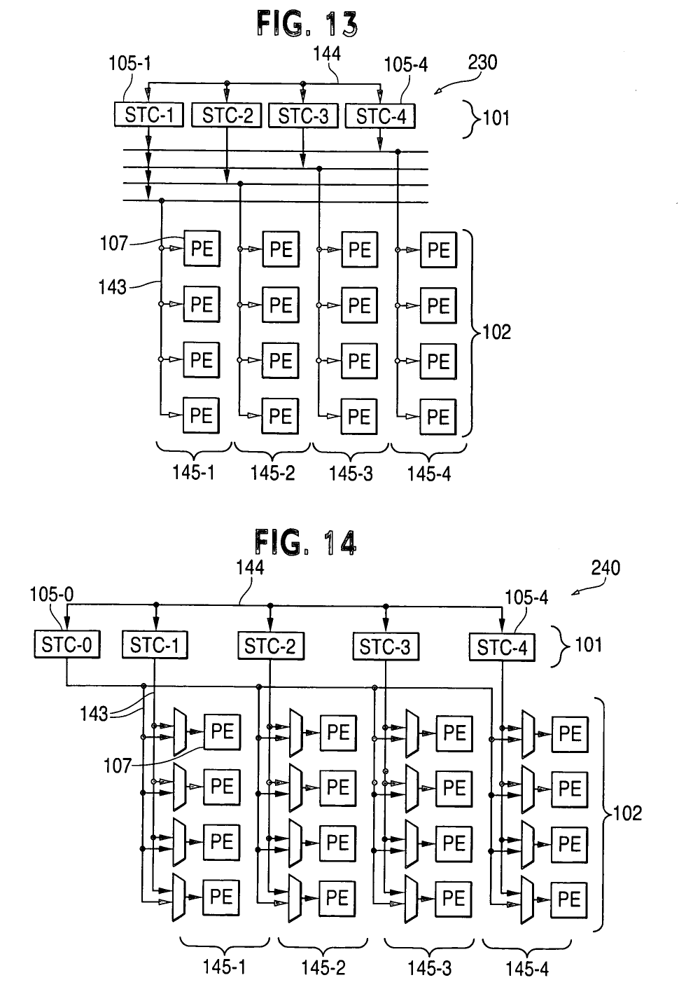

In array-type processor 230 that is shown in FIG. 13, only first state control unit 105-1 is freely connected to or disconnected from first to fourth element groups 145-1--145-4, second state control unit 105-2 is freely connected to or disconnected from second element group 145-2, third state control unit 105-3 is freely connected to or disconnected from third element group 145-3, and fourth state control unit 105-4 is freely connected to or disconnected from fourth element group 145-4.

In this array-type processor 230 as well, connecting first state control unit 105-1 to processor elements 107 of all element groups 145-1--145-4 can eliminate the need for linked operation by means of intercommunication of the plurality of state control units 105.

Tenth Embodiment

In array-type processor 240 that is shown in FIG. 14, only representative state control unit 105-0 is freely connected to or disconnected from first to fourth element groups 145-1--145-4, and each of first to fourth state control units 105-1--105-4 separately is freely connected to or disconnected from processor elements 107 of a corresponding element group of first to fourth element groups 145-1--145-4.

In this array-type processor 240 as well, connecting representative state control unit 105-0 to processor elements 107 of all element groups 145-1--145-4 can eliminate the need for linked operation by intercommunication between the plurality of state control units 105.

While preferred embodiments of the present invention have been described using specific terms, such description is for illustrative purposes only, and it is to be understood that changes and variations may be made without departing from the spirit or scope of the following claims.

What is claimed is:

1. An array-type processor in which a multiplicity of processor elements, which individually execute data processing in accordance with instruction codes for which data are individually set and for which a connection relation between the processor elements is switch-controlled, are arranged in rows and columns; and in which said instruction codes of this multiplicity of processor elements are successively switched by a state control unit; wherein:
said state control unit is composed of a plurality of units;
the multiplicity of said processor elements is divided into the number of element groups that corresponds to the number of said state control units; and
a plurality of said state control units and a plurality of said element groups are individually connected.

2. An array-type processor in which a multiplicity of processor elements, which individually execute data processing in accordance with instruction codes for which data are individually set and for which a connection relation between the processor elements is switch-controlled, are arranged in rows and columns; and in which said instruction codes of this multiplicity of processor elements are successively switched by a state control unit; wherein:
said state control unit is composed of a plurality of units; and
said array-type processor includes variable connection means for freely varying a connection relation between at least a portion of a plurality of said state control units and at least a portion of said multiplicity of processor elements.

3. An array-type processor according to claim 2, wherein said variable connection means freely varies a connection relation between all of the plurality of said state control units and all of the multiplicity of said processor elements.

4. An array-type processor according to claim 2, wherein said variable connection means regulates said processor elements that can be freely connected or disconnected from the plurality of said state control units.

5. An array-type processor according to claim 2, wherein:
at least a portion of the multiplicity of said processor elements is divided into a plurality of element groups; and
said variable connection means freely varies a connection relation between at least a portion of the plurality of said state control units and at least a portion of a plurality of said element groups.

6. An array-type processor according to claim 5, wherein:
the multiplicity of said processor elements is divided into the number of element groups that corresponds to said state control units; and
said variable connection means freely varies a connection relation between all of the plurality of said state control units and all of said plurality of said element groups.

7. An array-type processor according to claim 5, wherein said variable connection means regulates, for each of the plurality of said state control units, said element groups that can be freely connected or disconnected.

8. An array-type processor according to claim 7, wherein
the multiplicity of said processor elements is divided into the number of element groups that corresponds to said state control units; and
said variable connection means freely connects or disconnects a connection between at least nth (where n is a natural number) said state control unit and nth said element group.

9. An array-type processor according to claim 8, wherein said variable connection means freely connects or disconnects connections between at least nth said state control unit and (n±m)th (where m is a natural number that is less than n) said element group.

10. An array-type processor according to claim 5, wherein said variable connection means both freely connects or disconnects a portion of the plurality of said state control units and a portion of the plurality of said element groups and freely connects or disconnects a remaining portion of the plurality of said state control units and a remaining portion of the plurality of said element groups.

11. An array-type processor according to claim 5, wherein:
a portion of the plurality of said state control units is fixedly connected to a portion of the plurality of said element groups; and
said variable connection means freely connects or disconnects a remaining portion of the plurality of said state control units and a remaining portion of said plurality of element groups.

12. An array-type processor according to claim 5, wherein:
a portion of the plurality of said state control units is both fixedly connected to prescribed element groups of said element groups and freely connected to or disconnected from said processor elements of prescribed element groups of said element groups by said variable connection means; and
a remaining portion of the plurality of said state control units is freely connected to or disconnected from said processor elements of prescribed element groups of said element groups by said variable connection means.

13. An array-type processor according to claim 5, wherein said variable connection means freely connects or disconnects each of the plurality of said state control units and said processor elements of prescribed element groups of said element groups.

14. An array-type processor according to claim 1, wherein the plurality of said state control units intercommunicate to realize linked operation.

15. An array-type processor according to claim 2, wherein the plurality of said state control units intercommunicate to realize linked operation.

16. An array-type processor according to claim 5, wherein the plurality of said state control units intercommunicate to realize linked operation.

17. An array-type processor according to claim 7, wherein the plurality of said state control units intercommunicate to realize linked operation.

18. An array-type processor according to claim 8, wherein the plurality of said state control units intercommunicate to realize linked operation.
